(19) United States
(12) Patent Application Publication
(10) Pub. No.: US 2008/0317403 A1
(43) Pub. Date: Dec. 25, 2008

(54) Optical device

(75) Inventors: Teruhiro KUBO, Kawasaki (JP); Yoichi OIKAWA, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,363

(22) Filed: Jun. 18, 2008

(30) Foreign Application Priority Data
Jun. 21, 2007 (JP) 2007-163854

(51) Int. Cl. G02B 6/12; G02B 6/28

(52) U.S. Cl. 385/14; 385/24

(57) ABSTRACT

According to an aspect of the embodiment, an optical device having a light output device, a lens array and an angle changing device. The angle changing device is inputted a plurality of light from the lens array and outputs the plurality of light in predetermined output angle.

### BACKGROUND

This art relates to an optical device. The optical device preferably relates to an arrangement of a plurality of light.

As for recent networks, fast-access networks with bands of several Mbit/s to 100 Mbit/s such as Fiber To The Home (FTTH) and Asymmetric Digital Subscriber Line(ADSL), spread rapidly. An environment for enjoying broadband Internet services is improved with the fast-access networks.

Backbone network (core network) will be advancing to construct super-large-capacity optical communication systems with Wavelength Division Multiplexing (WDM) technology in response to increase in communication demands.

At a connection portion between a metropolitan area network and a core network, there is misgiving about bandwidth bottleneck due to a limit of an electrical switching capacity. Then, such a new photonic network architecture is researched and developed that a new optical switching node is installed to a metropolitan area as the bandwidth bottleneck and the metropolitan area network directly-accessed by a user is directly connected to the core network in an optical area, not via an electrical switch.

There is an optical gate switch as the optical switching node for directly connecting the core network and metropolitan area network with light. The optical gate switch switches the connection by direct light by using a semiconductor optical amplifier (SOA), not via the electrical switch.

FIG. 8 is a diagram showing the structure of a conventional optical gate switch. Referring to FIG. 8, the optical gate switch has an input fiber 101, a coupler 102, SOAs 103a to 103d, and output fibers 104a to 104d.

The light received from the input fiber 101 is output to the coupler 102. The coupler 102 divides the received light and outputs the light to the SOAs 103a to 103d.

The SOAs 103a to 103d have functions of gate elements. The SOAs 103a to 103d are turned on/off, thereby passing/cutting-off the light output from the coupler 102 through/to the output fibers 104a to 104d. The output fibers 104a to 104d output the light turned-on/off by the SOAs 103a to 103d to a desired output route. Although the SOAs 103 to 103d are individually shown in FIG. 8, they may be manufactured as one chip array. Further, although the output fibers 104a to 104d are individually shown therein, they may be manufactured as one fiber array.

FIG. 9 is a diagram showing the details of an optical coupling system of the SOA array and the output fiber array shown in FIG. 8. Referring to FIG. 9, an SOA array 111 and an output fiber array 114 are shown. Unlike FIG. 8, microlens arrays 112 and 113 are shown in FIG. 9.

The SOA array 111 has a plurality of SOAs 111a to 111d. The SOAs 111a to 111d correspond to the SOAs 103a to 103d shown in FIG. 8. The output fiber array 114 has a plurality of optical fibers 114a to 114d. The optical fibers 114a to 114d correspond to the output fibers 104a to 104d shown in FIG. 8.

The light output from the SOAs 111a to 111d in the SOA array 111 is input to microlenses in the microlens array 112. The microlenses suppress the spreading of the light output from the SOAs 111a to 111d, and output the light in parallel therewith.

The light output from the microlens array 112 is input to the microlens array 113. Micro lenses in the microlens array 113 set the spreading light output from the microlens array 112 to be in parallel therewith, and output the set light to the output fiber array 114.

An Japanese Laid-open Patent Publication No. 09-19785 discusses an optical device for laser-beam processing. The optical device includes a wedge prism which is inserted in a portion of optical beam for power splitting.

However, if the route of the light output from the SOA shifts from the center of the microlens, the light is refracted from the microlens and is output. Therefore, there is a problem of deterioration in optical coupling efficiency of the optical coupling system.

FIG. 10 is a diagram for illustrating the optical coupling efficiency of the optical coupling system. Referring to FIG. 10, the same reference numerals as those in FIG. 9 are designated to the same components, and a description thereof will be omitted.

Preferably, the pitch between the SOAs 111a to 111d in the SOA array 111 is the same as the pitch between the microlenses in the microlens array 112. However, the pitch of the SOA array 111 cannot be the same as that of the microlens array 112 on the manufacture.

In this case, the light output from the SOA does not pass through the center of the microlens, but is refracted and output from the microlens. In particular, one end of the SOA array 111 is matched to that of the microlens array 112 so as to structure the optical coupling system. Then, as the position is nearer the other end thereof, the offset between the SOA and the microlens becomes larger and the light is greatly refracted and is output.

In an example shown in FIG. 10, the optical coupling system is structured so that the SOA 111d on the bottommost side in the SOA array 111 matches the center position of the microlens on the bottommost side in FIG. 10 in the microlens array 112. In this case, the position of the SOA 111a on the uppermost side in FIG. 10 greatly shifts from the position of the microlens corresponding thereto. As a consequence, the route of the light output from the SOA 111a is extremely far from the center of the microlens, and the light output from the microlens is greatly refracted and is output.

When the pitch of the SOA array 111 is not the same as the pitch of the microlens array 112 as mentioned above, the light output from the microlens array 112 is individually output with different output angles, as shown by an arrow in FIG. 10. Therefore, the optical coupling efficiency deteriorates in the microlens array 113 that receives the light output from the microlens array 112.

### SUMMARY

Accordingly, it is an object of an aspect of embodiment of the invention to provide an optical device that ameliorates optical coupling efficiency of the optical coupling in optical device.

According to an aspect of the embodiment, an optical device having a light output device, a lens array and an angle changing device.

The angle changing device is inputted a plurality of light from the lens array and outputs the plurality of light in predetermined output angle.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention.

### BRIEF DESCRIPTION OF THE DRAWINGS

FIG. 1 is a diagram for illustrating the outline of an optical device.

FIG. 2 is a diagram for illustrating the optical coupling efficiency upon causing the offset in an input/output optical system of light.

FIG. 3 is a diagram for illustrating the optical coupling efficiency upon causing the angle deviation in the input/output optical system of light.

FIG. 4 is a diagram for illustrating the optical coupling efficiency upon causing the offset between an SOA and a microlens.

FIG. 5 is a diagram for illustrating correction of the angle deviation of light through a wedge prism.

FIG. 6 is a diagram showing an example of an optical device in an optical coupling system using the wedge prism.

FIG. 7 is a diagram showing another example of the optical device in the optical coupling system using the wedge prism.

FIG. 8 is a diagram showing the structure of a conventional optical gate switch.

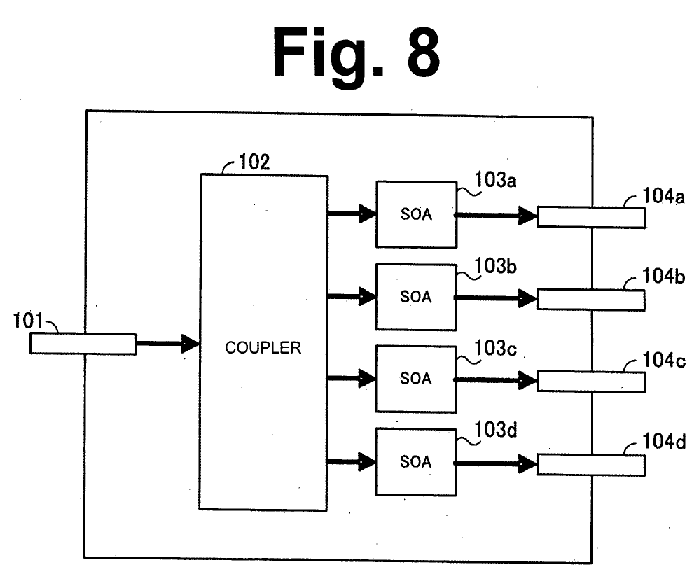

FIG. 9 is a diagram showing details of an optical coupling system of an SOA array and an output fiber array shown in FIG. 8.

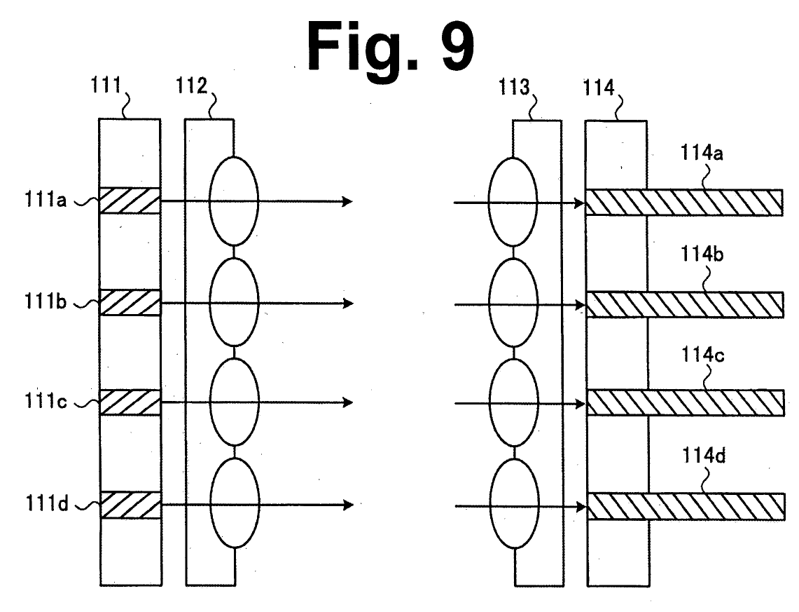

FIG. 10 is a diagram for illustrating the optical coupling efficiency of an optical coupling system.

### DETAILED DESCRIPTION OF THE PREFERRED EMBODIMENTS

Hereinbelow, the invention will be explained in detail with reference to the drawings of embodiments.

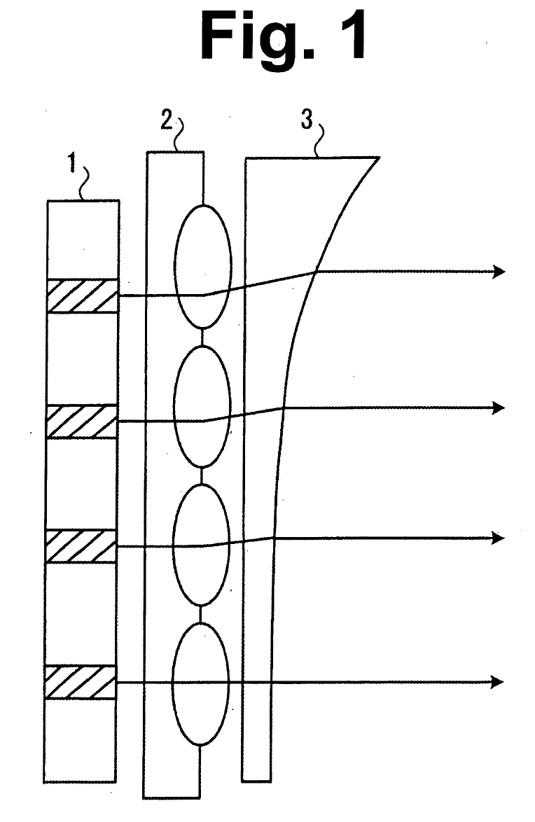

FIG. 1 is a diagram for illustrating the outline of an optical device. Referring to FIG. 1, the optical device has an optical output array 1, a lens array 2, and a wedge prism 3.

The optical output array 1 is an example of light output device. The optical output array 1 outputs a plurality of light in parallel. The plurality of the light has a pitch between the light. The optical output array 1 is, for example, an SOA array having a plurality of SOAs, or an optical fiber array having a plurality of optical fibers.

The lens array has a plurality of lenses. The lenses have a pitch between the lenses. The lens array 2 receives the plurality of light output from the optical output array 1. Although the pitch between the lenses in the lens array 2 is preferably the same as the pitch between the plurality of light output by the optical output array 1 but the pitch of the light and the pitch of the lenses can be different from each other on the manufacture. In this case, the plurality of light output from the lens array 2 is respectively output with different output angles, as shown in FIG. 1.

The wedge prism 3 is an example of angle changing device of the embodiment. The wedge prism 3 outputs the plurality of light with different output angles output from the lens array 2, with the same output angle.

Hence, in the optical device, the plurality of light output with different output angles from the lens array 2 is output with the same output angle through the wedge prism 3. Accordingly, the receiving side for receiving the plurality of the light can receive the light without producing the angle deviation and can thus suppress the deterioration in optical coupling efficiency of the plurality of light.

Next, an embodiment of the invention will be described in detail with reference to the drawings. First of all, the optical coupling efficiency will be explained.

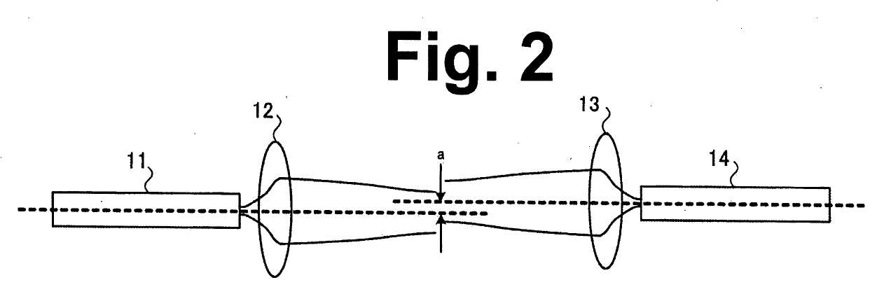

FIG. 2 is a diagram for illustrating the optical coupling efficiency upon causing the offset produced in input/output optical systems of light. Referring to FIG. 2, an SOA 11, microlenses 12 and 13, and an optical fiber 14 are shown. The SOA 11 is arranged at the focal position of the microlens 12, and the optical fiber 14 is arranged at the focal position of the microlens 13.

The SOA 11 outputs the light to the microlens 12. The microlens 12 outputs the light to the microlens 13, and is output to the optical fiber 14.

The light output from the SOA 11 is spread, as shown in FIG. 2. The spreading light outputted from the SOA 11 converges by the microlens 12 which consequently outputs the light outputted from the SOA 11 to be in parallel therewith or to be narrower. The microlens 13 outputs the light outputted from the microlens 12 so as to converge the light to the optical fiber 14.

As shown in FIG. 2, the light beam radius from the SOA 11 is outputted from the microlens 12 with a larger beam radius. Further, the microlens 13 outputs a converging light with a large beam radius to the optical fiber 14, as shown in FIG. 2, Therefore, even if an offset arises between the position of the input optical system of the SOA 11 and microlens 12 and the position of the output optical system of the microlens 13 and optical fiber 14, this does not have a serious influence as the deterioration in optical coupling efficiency.

As shown in a FIG. 2, it is assumed that an offset ‘a’ arises between the position of the input optical system of the SOA 11 and microlens 12 and the position of the output optical system of the microlens 13 and optical fiber 14. In this case, if the offset ‘a’ has a value smaller than the beam radius, this does not have the serious influence as the deterioration in optical coupling efficiency.

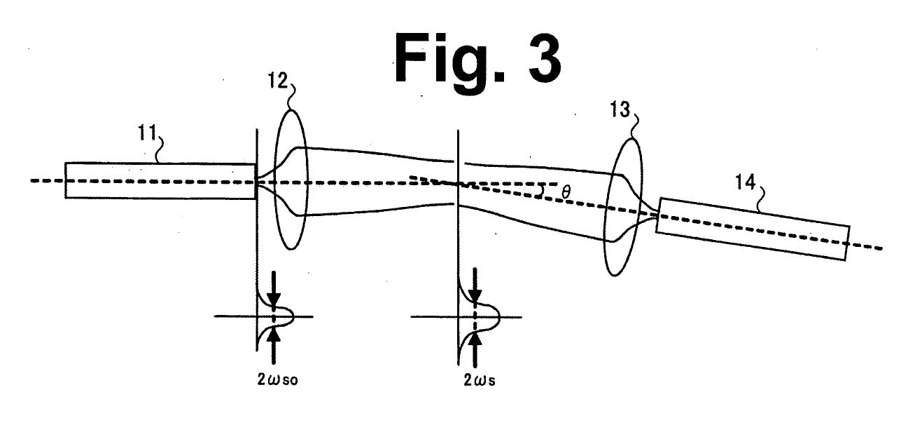

FIG. 3 is a diagram for illustrating the optical coupling efficiency upon causing the angle deviation in the input/output optical system of light. Referring to FIG. 3, the same reference numerals as those in FIG. 2 are given to the same components shown therein, and the explanation is omitted.

In FIG. 3, an angle deviation ‘θ’ arises between the input optical system of the SOA 11 and microlens 12 and the output optical system of the optical fiber 14 and microlens 13. Incidentally, 2ωso in FIG. 3 denotes the beam diameter of the light at the output portion of the SOA 11, and ωso denotes radius of the light at the output portion of the SOA 11. 2ωs denotes the light beam diameter at the focal position of the microlens 12, and ωs denotes the light beam radius at the focal position of the microlens 12.

An optical coupling efficiency η as a consequence of the angle deviation between the input optical system and the output optical system in FIG. 3 is expressed by the following formula.

η=exp{(−θ·ωs·π/λ) [symbol] 2} (1)

Incidentally, λ in the formula (1) denotes a wavelength of light. As expressed in the formula (1), as the angle deviation (θ) between the input optical system and the output optical system becomes larger, it is obviously understood that the optical coupling efficiency η exponentially decreases.

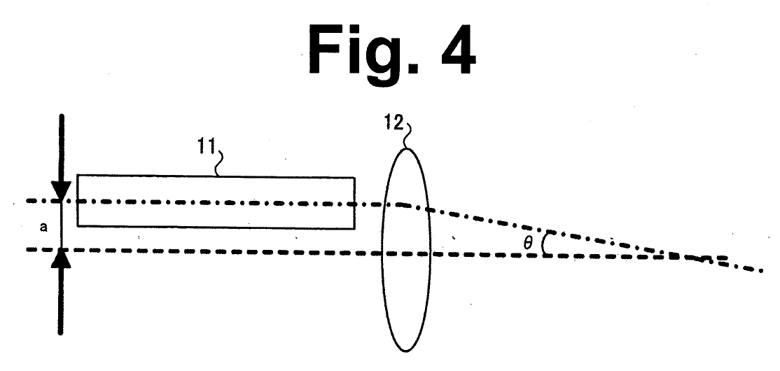

FIG. 4 is a diagram for illustrating the optical coupling efficiency upon causing the offset between the SOA and the microlens. Referring to FIG. 4, the SOA 11 and the microlens 12 shown in FIG. 2 are shown.

As shown in FIG. 4, it is assumed that the offset ‘a’ arises between the optical axis of the light output from the SOA 11 and the center position of the microlens 12. In this case, the angle deviation of ‘θ’ arises in the light outputted from the SOA 11 and is output from the microlens 12, as shown in FIG. 4.

Therefore, the optical coupling efficiency η of the optical system shown in FIG. 4 becomes the same angle deviations of the input optical system and the output optical system as mentioned above with reference to FIG. 3, and is expressed by the formula (1). That is, the offset between the optical axis of the light output from the SOA 11 and the center position of the microlens 12 exponentially decreases the optical coupling efficiency η.

Herein, the optical coupling efficiency η is expressed by using the offset a. There is a relationship expressed by the following formula between the beam radius ωso and the beam-radius ωs shown in FIG. 3.

ωs=λ·f/(π·ωso) (2)

Incidentally, f in the formula (2) denotes the focal distance of the microlens 12.

Further, there is a relationship expressed by the following formula between the offset a and the angle deviation θ.

θ=a/f (3)

The following formula is obtained by substituting the formulae (2) and (3) for the formula (1).

η=exp{(−a/ωs) [symbol] 2} (4)

As expressed by the formula (4), obviously, the optical coupling efficiency η exponentially decreases by the offset ‘a’ between the SOA 11 and the microlens 12.

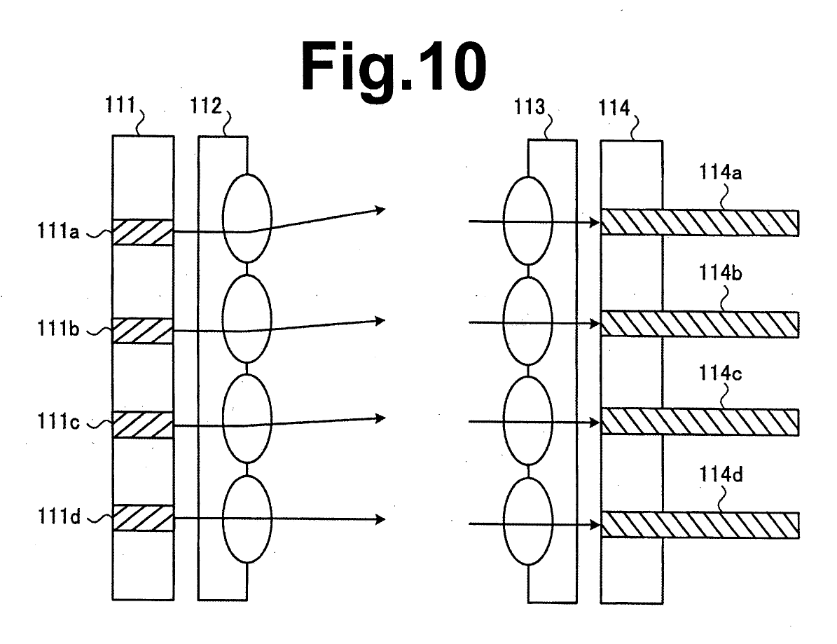

As explained with reference to FIG. 10, the pitch of the SOA array 111 can shift from the pitch of the microlens array 112 on the manufacture. In this case, since the angle deviation of the light arises as described with reference to FIG. 4, the optical coupling efficiency extremely deteriorates. Then, a wedge prism is inserted to the output side of the microlens array and the angle deviation is corrected so as to set all the output angles of the light output from the microlens arrays to have the same angle. Thereby, without causing the angle deviation, the microlens array in the output optical system can receive the light, and the deterioration in optical coupling efficiency can be suppressed. Hereinbelow, a description will be given of the correction of the angle deviation of light through the wedge prism.

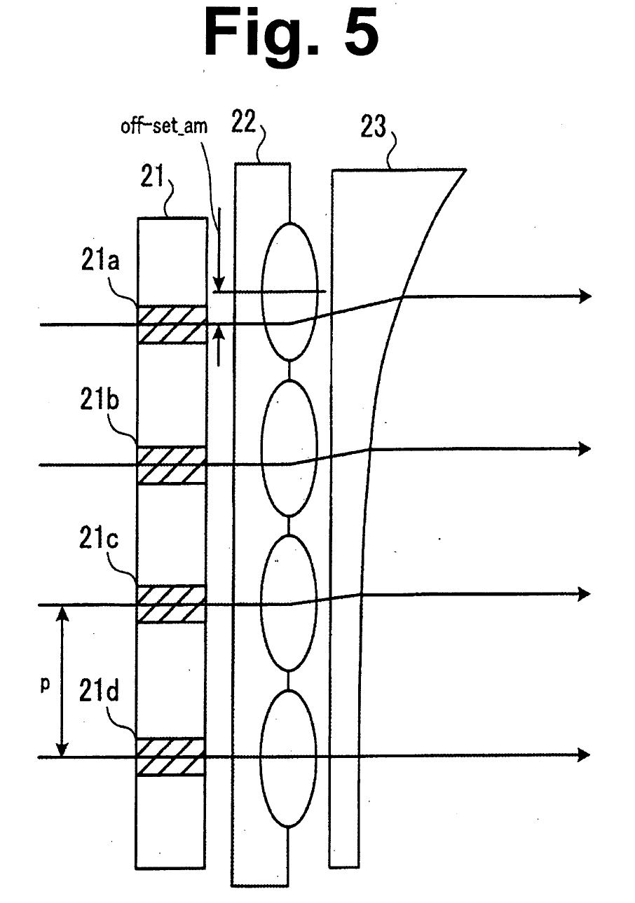

FIG. 5 is a diagram for illustrating the correction of the angle deviation of light through the wedge prism. Referring to FIG. 5, an SOA array 21, a microlens array 22, and a wedge prism 23 are shown. The SOA array 21 has SOAs 21a to 21d. The wedge prism 23 is an example of angle changing device of the embodiment. The SOA array 21 is an example of light output device.

Reference numeral ΔX denotes an error between the pitch between the SOAs 21a to 21d and the pitch between microlenses in the microlens array 22. It is assumed that the SOA 21d on the bottommost side in FIG. 5 matches the center position of the microlens corresponding thereto. Then, the following formula expresses an offset off-set_am between an m-th microlens (herein, the microlens on the bottommost side in FIG. 5 is set as a first microlens) in the microlens array 22 and the SOA in the SOA array 21 corresponding thereto.

Off-set_{—}am=(m−1)·ΔX (11)

Therefore, an output angle θm of the light from the m-th microlens is expressed by the following formula.

θm=off-set_{—}am/f (12)

Incidentally, f denotes the focal distance of the microlens.

When the formula (11) is substituted for the formula (12), the output angle θ of light is expressed by the following formula.

θm=(m−1)·ΔX·(1/f) (13)

Since an input position ri of arbitrary light is set to ri=(m−1)·p where reference numeral p denotes the pitch between the SOAs 21a to 21d in the SOA array 21, the formula (13) is expressed by the following formula.

θm=(m−1)·ΔX·(1/f)=(1/f)·(ri/p)·ΔX=ro′ (14)

Herein, an ABCD light matrix is defined by the following formula.

$$( \begin{matrix}ro \\ {ro}^{′}\end{matrix} ) = ( \begin{matrix}A & B \\ C & D\end{matrix} ) ( \begin{matrix}ri \\ {ri}^{′}\end{matrix} ) \qquad ( 15 )$$

Therefore, the ABCD light matrix of the microlens array 22 in FIG. 5 is expressed by the following formula.

$$( \begin{matrix}ro \\ {ro}^{′}\end{matrix} ) = ( \begin{matrix}1 & 0 \\ \frac{Δ XI}{f \cdot p} & 1\end{matrix} ) ( \begin{matrix}ri \\ {ri}^{′}\end{matrix} ) \qquad ( 16 )$$

A curved surface of the wedge prism 23 is assumed to a concave surface, and a radius of curvature is set to Rc. Further, a refractive index of the wedge prism 23 is set to n. In this case, the ABCD light matrix of the wedge prism 23 can apply an ABCD light matrix of a concave-surface medium, and is expressed by the following formula.

$$( \begin{matrix}ro \\ {ro}^{′}\end{matrix} ) = ( \begin{matrix}1 & 0 \\ \frac{n - 1}{- Rc} & 1\end{matrix} ) ( \begin{matrix}ri \\ {ri}^{′}\end{matrix} ) \qquad ( 17 )$$

Therefore, if the following formula is satisfied based on the formulae (16) and (17), all of the output angles at an arbitrary position can be identical.

ΔX/(f·p)=(−1)·{(n−1)/(−Rc)} (18)

The formula (18) is transformed and the radius of curvature Rc of the caved surface of the wedge prism 23 is obtained, and the following formula is then expressed.

Rc={p·f·(n−1)}/ΔX (19)

In fact, the radius Rc of curvature of the concave surface of the wedge prism 23 is set to satisfy the formula (19). Then, all the light at different angles output from the microlens array 22 shown in FIG. 5 is output with the same output angle.

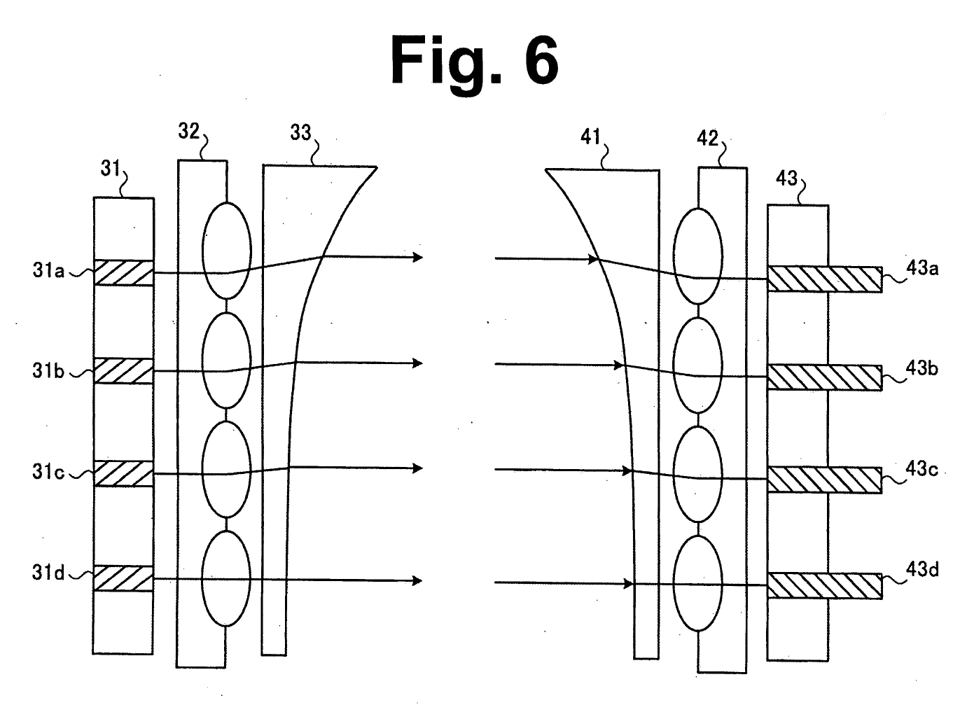

FIG. 6 is a diagram showing an example of the optical device of the optical coupling system using the wedge prism. The optical device in the optical coupling system shown in FIG. 6 includes an SOA array 31, microlens arrays 32 and 42, wedge prisms 33 and 41, and an output fiber array 43. The wedge prism 33 and 41 are an example of angle changing device of the embodiment. The SOA array 31 is an example of light output device. The output fiber array 43 is an example of light input device.

The SOA array 31 has a plurality of SOAs 31a to 31d. The SOAs 31a to 31d in the SOA array 31 are formed on a chip with an equal interval. Therefore, the plurality of the light has same pitch.

Although not shown, the light from an input fiber is distributed and input to the SOAs 31a to 31d in the SOA array 31. The SOAs 31a to 31d in the SOA array 31 are turned on/off, and passes/cuts off the light input through the microlens array 32. Incidentally, the SOAs 31a to 31d can amplify and output the light and can compensate for the loss caused by the switching.

The microlens array 32 has a plurality of microlenses. The microlenses in the microlens array 32 are formed at an equal interval.

The microlens array 32 suppresses the spreading of the light output from the SOAs 31a to 31d, and outputs the light in parallel therewith. Although the pitch between the microlenses in the microlens array 32 is preferably identical to the pitch between the SOAs 31a to 31d in the SOA array 31, both the pitches can shift from each other on the manufacture. If the pitches shift from each other, the light output from the microlens is output with different angles, as shown in FIG. 6.

The wedge prism 33 corrects all the light output from the microlens array 32 with the same output angle and outputs the corrected light. The curved surface of the wedge prism 33 is a concave surface, and the radius of curvature satisfies the formula (19). Reference numeral p denotes the pitch between the light output from the SOA array 31, reference numeral ΔX denotes the deviation in pitch between the microlenses in the microlens array 32 and the SOAs 31a to 31d in the SOA array 31, reference numeral f denotes the focal distance of the microlens array 32, and reference numeral n denotes a refractive index of the wedge prism 33.

The light through from the wedge prism 33 is input to a wedge prism 41. The wedge prism 41 inputs the received light to the microlens array 42.

The microlens array 42 condenses the spreading light output through the wedge prism 41 to output fibers 43a to 43d in the output fiber array 43.

The pitch between the microlenses in the microlens array 42 cannot be identical to the pitch between the output fibers 43a to 43d in the output fiber array 43. In this case, incident angles of proper light of the microlenses in the microlens array 42 differ from each other, as shown in FIG. 6. Therefore, if the parallel light output through the wedge prism 33 is directly incident on the microlens array 42, the optical coupling efficiency deteriorates.

However, by also using the wedge prism 41 for the output optical system, the incident angle of light can be properly corrected and can be incident on the microlens array 42. That is, the deterioration in optical coupling efficiency is suppressed by inputting the light output to the microlens array 42 through the wedge prism 33 with the wedge prism 41 in consideration of the deviation between the pitch of the microlens array 42 and the pitch of the output fiber array 43.

Also in the wedge prism 41 in the output optical system, the radius of curvature can be computed like the formula (19). For example, the curved surface of the wedge prism 41 is a concave surface, and the radius of curvature satisfies the formula (19). Incidentally, reference numeral p denotes the pitch between the output fibers 43a to 43d in the output fiber array 43, reference numeral ΔX denotes the deviation between the pitch of the microlenses in the microlens array 42 and the pitch of the output fibers 43a to 43d in the output fiber array 43, reference numeral f denotes the focal distance of the microlens array 42, and reference numeral n denotes a refractive index of the wedge prism 41.

Thus, through the wedge prism 33, output angles of a plurality of light output from the microlens array 32 are identical. Thus, the deterioration in optical coupling efficiency in the output optical system can be suppressed.

Further, through the wedge prism 41, the plurality of light output in parallel therewith is corrected to that with a predetermined incident angle, and the corrected light is incident on the microlens array 42. As a consequence, even if the pitch of the microlens array 42 in the output optical system is not the same as the pitch of the output fiber array 43, the deterioration in optical coupling efficiency can be suppressed.

Incidentally although the light is output from the SOA array 31 in FIG. 6, the output source of the light is not limited to the SOA array. For example, a portion corresponding to the SOA array 31 may output a plurality of light to the microlens array, such as a fiber array. In this case, through the wedge prism 33, the output angles of a plurality of light can also be identical.

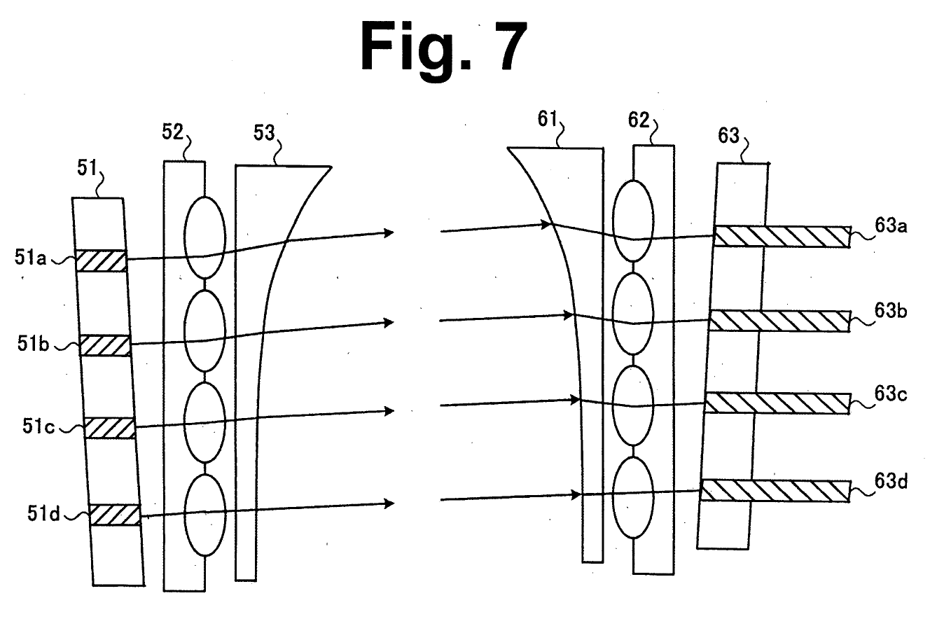

FIG. 7 is a diagram showing another example of the optical device in the optical coupling system using the wedge prism. The optical device in the optical coupling system shown in FIG. 7 includes an SOA array 51, microlens arrays 52 and 62, wedge prisms 53 and 61, and an output fiber array 63. The wedge prism 53 and 61 are an example of angle changing device of the embodiment. The SOA array 51 is an example of light output device. The output fiber array 63 is an example of light input device.

Parts in FIG. 7 are the same as those in FIG. 6, and the detailed explanation thereof is omitted. However, unlike FIG. 6, in FIG. 7, end surfaces for outputting light from SOAs 51a to 51d in the SOA array 51 are diagonal to the microlens array 52. Further, end surfaces for inputting the light from output fibers 63a to 63d in the output fiber array 63 are diagonal to the microlens array 62. The end surfaces of the SOA array 51 and the output fiber array 63 are diagonal, thereby preventing the reflection to the end surfaces of the SOA array 51 and the output fiber array 63.

The pitch between the SOAs 51a to 51d in the SOA array 51 is not the same as the pitch between the microlenses in the microlens array 52, and the light output from the microlens array 52 is individually output with different output angles. Further, since the end surface of the SOA array 51 is arranged to be diagonal to the microlens array 52, the light output from the SOAs 51a to 51d is diagonally incident on the microlenses, and the light outputted from the microlens array 52 is consequently outputted with different output angles. The wedge prism 53 respectively corrects the light output with different output angles to have the same output angle, and outputs the corrected light to the wedge prism 61 in the output optical system.

The light output through the wedge prism 53 is incident on the wedge prism 61. The wedge prism 61 inputs the received light to the microlens array 62.

The microlens array 62 outputs, to the output fiber array 63, the spreading light output through the wedge prism 61 to be condensed to the output fibers 63a to 63d in the output fiber array 63.

The pitch between the microlenses in the microlens array 62 is not the same as the pitch between the output fibers 63a to 63d in the output fiber array 63, and incident angles of proper light through the microlenses in the microlens array 62 respectively differ from each other. Further, since the end surface of the output fiber array 63 is arranged to be diagonal to the microlens array 62, the incident angles of the proper light through the microlenses are respectively varied. The wedge prism 61 corrects the light in accordance with the pitch deviation and the diagonal arrangement of the output fiber array 63, and inputs the corrected light to the microlens array 62.

In the optical device shown in FIG. 7, the beams between the wedge prisms 53 and 61 are oblique to the optical device shown in FIG. 6 by diagonally setting the end surfaces of the SOA array 51 and the output fiber array 63. In the optical device shown in FIG. 7, importantly, the beams output through the wedge prism 53 have the same output angle, similarly to the optical device shown in FIG. 6, and the beams between the wedge prism 53 and the wedge prism 61 have the same angle (an arrow extended from the wedge prism 53 in FIG. 7 is parallel with an arrow directed to the wedge prism 61). Because there is no influence on optical coupling efficiency due to the beams in parallel with each other between the wedge prism 53 and the wedge prism 61 if some offset arises in the input optical system and the output optical system, as explained above with reference to FIG. 2.

Although the radius of curvature of the wedge prism 53 is computable like the formulae (11) to (19), the output angle θm of the light output from the microlens array 52 differs. That is, since the end surface of the SOA array 51 is diagonal, it is necessary to take the angle of the light output from the SOA array 51 into consideration of θm in the formula (12) and to calculate the formulae (12) to (19) again. The wedge prism 61 in the output optical system is similar.

Thus, even if the end surfaces of the SOA array 51 and the output fiber array 63 are individually diagonal to the microlens arrays 52 and 62, the deterioration in optical coupling efficiency can be suppressed.

What is claimed is:

1. An optical device comprising:
a light output device for outputting a plurality of light;
a lens array having a plurality of lenses, the lenses inputting the plurality of light from the light output device and outputting the plurality of light, respectively; and
an angle changing device inputted the plurality of light from the lens array and for outputting the plurality of light in predetermined output angle, respectively.

2. The optical device of the claim 1,
wherein the lens array has a plurality of first pitches P between the lenses;
wherein the lenses having focal length f;
wherein the plurality of the light outputted form the light output device has second pitches, the second pitch having a deviation X from the first pitch;
wherein the angle changing device has an input surface and an output surface and a refractive index n, the output surface having a radius of curvature from the equation; the radius of curvature={p·f·(1−n)}/ΔX.

3. The optical device of the claim 1, wherein the light output device has a plurality of semiconductor optical amplifiers, the optical amplifiers outputting the plurality of the light, respectively.

4. An optical device comprising:
a light output device for outputting a plurality of light;
a first lens array having a plurality of first lenses, the first lenses inputting the plurality of light from the light output device and outputting the plurality of light, respectively;
a first angle changing device inputted the plurality of light from the first lens array and for outputting the plurality of light in predetermined output angle, respectively;
a second angle changing device inputted the plurality of light from the first prism and for outputting the plurality of light in predetermined output angle, respectively;
a second lens array having a plurality of second lenses, the second lenses inputting the plurality of light from the second angle changing device and outputting the plurality of light, respectively;
a light input device inputted the plurality of light from the second angle changing device to a plurality of light receiving portions.

5. The optical device of the claim 4,
wherein the first lens array and the second lens array have a plurality of first pitches P between the first lenses;
wherein the first lenses and second lenses have focal length f;
wherein the plurality of the light outputted form the light output device and the plurality of the light receiving portions have second pitches, the second pitch having a deviation X from the first pitch;
wherein the first angle changing device and second angle changing device have an input surface and an output surface and a refractive index n, the output surface having a radius of curvature from the equation, the radius of curvature={p·f·(1−n)}/ΔX , respectively.
